(19) United States
(12) Patent Application Publication
(10) Pub. No.: US 2010/0199185 A1
(43) Pub. Date: Aug. 5, 2010

(54) COMMON NAVIGATION MECHANISM FOR DESKTOP AND BROWSER-BASED APPLICATIONS

(75) Inventors: Steven Miles Greenberg, Seattle, WA (US); Vitore Selca, Bellevue, WA (US); Andrew Robert Miller, Issaquah, WA (US); Stephen Lesser, Redmond, WA (US); Clinton Dee Covington, Redmond, WA (US); Ryan McMinn, Seattle, WA (US); Pavel R. Karimov, Redmond, WA (US); Konrad Tupaj, Kirkland, WA (US); Amarinder Singh Grewal, Redmond, WA (US); Robert Scott Cooper, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/365,179

(22) Filed: Feb. 4, 2009

(51) Int. Cl. G06F 3/048

(52) U.S. Cl. 715/733

(57) ABSTRACT

A client application provides a user interface for defining a form that includes a navigation control. The navigation control includes two or more selectable tabs that are each associated with a target, such as another form or a report. When one of the selectable tabs on the navigation control is selected using an appropriate user input device, the target associated with the selected tab is displayed in the form. The client application also provides functionality for publishing a form including navigation controls to a server application, thereby making the form and the navigation control accessible through a Web interface.

### BACKGROUND

Some database management programs allow developers to create database applications for performing certain functions with respect to a database. For instance, a database application might be created that allows a user to track donations to a school or charity. Users typically access database applications like this one through the database management program (referred to herein as a “database client application program” or simply a “database client”) utilized to create the database application or a runtime version of the database client. As a result, a user that does not have a copy of the database client or a runtime version installed on their computer will not be able to utilize the database application.

In order to facilitate collaboration and to allow users without a copy of the database client application program to access and utilize a database application, a version of the database application may be created that can be accessed using a World Wide Web (“Web”) browser and a local or wide area network. However, the creation of a Web-accessible database application in this manner can be a complicated and expensive process. Moreover, it can be difficult to ensure that the database client application program and the Web-accessible database application provide a consistent user interface, including any user interface mechanisms for navigating the application. The Web-accessible version of the application cannot be taken offline, so the database client application is utilized to interact with the application in this scenario.

It is with respect to these considerations and others that the disclosure made herein is presented.

### SUMMARY

Technologies are described herein for providing a common user interface navigation mechanism for desktop and Web browser-based application programs. In particular, through an implementation of the concepts and technologies presented herein, a desktop client application and a Web-based browser-accessible application can be easily and quickly created that utilize a common user interface navigation mechanism.

According to one embodiment presented herein, a client application, such as a database client application program, provides a user interface for defining a form that includes a navigation control. In one embodiment, the navigation control includes one or more selectable tabs that are each associated with a target, such as another form or a report. When one of the selectable tabs on the navigation control is selected using an appropriate user input device, the target associated with the selected tab is displayed in the form. Multiple navigation controls may be added to the same form. The client application may also provide a user interface for interacting with a form to utilize a navigation control to view two or more targets.

According to other embodiments, the client application also provides functionality for publishing an application that has a form including one or more navigation controls to a server application, thereby making the form accessible through a Web interface. In response to receiving a request to publish a form in this manner, the form including the navigation control is published to a server computer executing the server application. The server application is configured to make the form, including the navigation control, accessible through a Web interface. In this manner, a consistent navigation mechanism can be easily provided between a client interface and Web-based interface of an application.

It should be appreciated that the above-described subject matter may also be implemented as a computer-controlled apparatus, a computer process, a computing system, as an article of manufacture such as a computer-readable medium, or in another manner. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network and computer architecture diagram showing aspects of an illustrative operating environment and several software components provided by the embodiments presented herein;

FIGS. 2A-5B are user interface diagrams showing aspects of the operation of creation and use of a navigation control provided in embodiments presented herein;

FIG. 6 is a user interface diagram showing aspects of one user interface provided herein for adding tabs to a navigation control and for defining targets in one embodiment;

FIG. 7 is a flow diagram showing aspects of one process for providing a navigation control in a client application in one embodiment presented herein;

FIG. 8 is a flow diagram showing aspects of one process presented herein for providing a navigation control in a Web-based application; and

FIG. 9 is a computer architecture diagram showing an illustrative computer hardware and software architecture for a computing system capable of implementing aspects of the embodiments presented herein.

### DETAILED DESCRIPTION

The following detailed description is directed to technologies for providing a common user interface navigation mechanism between a desktop client application and a Web-based version of the application. As will be discussed in greater detail below, the embodiments presented herein allow the creation of custom, forms-based navigation for a database application program without the need for switchboards or for writing code behind forms and user interface buttons. In particular, the embodiments presented herein permit the easy creation of a navigation form that includes a navigation control by default. The navigation control may be laid out in different ways, including but not limited to a series of tabs across the top of the form, down either side of the form, or a drop-down menu. Moreover, multiple navigation controls can be tied together so that one control cascades into another. Forms, reports, and other visualizations may also be easily added as targets of the tabs of the navigation control. The navigation form and navigation control may also be easily made available through a desktop application or a Web interface.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, concepts and technologies for providing a common navigation mechanism for database client and Web-based applications will be described.

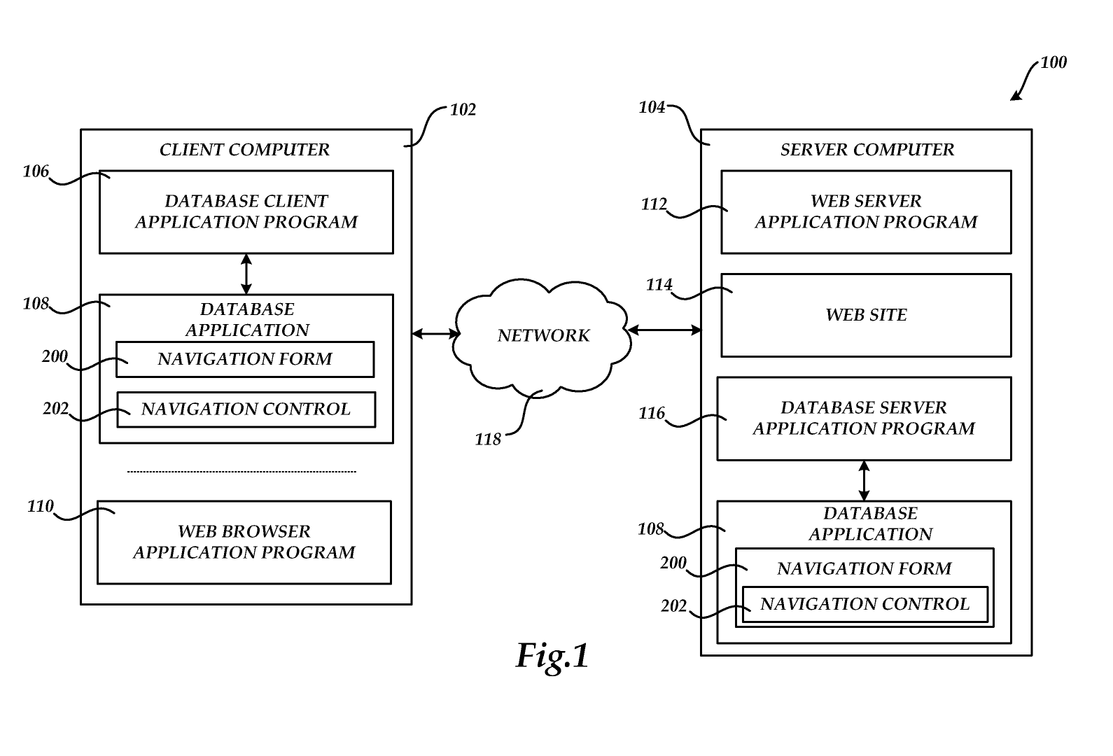

Turning now to FIG. 1, details will be provided regarding an illustrative operating environment and several software components provided by the embodiments presented herein. In particular, FIG. 1 shows aspects of a system 100 for providing a common navigational mechanism for desktop and browser-based application programs. As shown in FIG. 1, the system 100 includes a client computer 102 and a server computer 104 that are interconnected by a network 118. It should be appreciated that the configuration illustrated in FIG. 1 is merely illustrative and that additional computing systems and networks not shown in FIG. 1 may be utilized in various embodiments presented herein. It should also be appreciated that while the network 118 is described herein as being a wide area network (“WAN”), such as the Internet, other types of local and WANs may also be utilized by the embodiments presented herein.

As illustrated in FIG. 1, the client computer 102 is equipped to execute an operating system and appropriate application program software for embodying the various aspects presented herein. According to one embodiment, various aspects presented herein are embodied within a database client application program 106. The database client application program 106, which may be referred to herein simply as the “database client”, comprises a database application program configured for execution on a client computer 102. For instance, in one implementation, the database client application program 106 comprises the ACCESS database client application program from MICROSOFT CORPORATION of Redmond, Wash. It should be appreciated, however, that database client application programs from other vendors may also be utilized to embody the various aspects presented herein. It should be further appreciated that while the embodiments presented herein are described in the context of a database client application program, the various aspects described herein may be utilized with any type of application program that provides functionality for providing views of a data set, such as through the provision of forms or reports.

As also illustrated in FIG. 1, the database client application program 106 is configured in embodiments to allow a user to create a database application 108. The database application 108 may be executed by the database client application program 106 or a runtime version of the database client. Through the use of the database application 108, a user of the client computer 102 can interact with a database in various ways supported by the database application 108. It should be appreciated that, in one embodiment, the database application 108 is self contained, including the actual database upon which the database application 108 operates.

According to one embodiment presented herein, the database client application program 106 is further configured to allow a user to define a navigation form 200 as part of database application 108. As will be discussed in greater detail below, the navigation form 200 may include a navigation control 202. The navigation control 202 includes selectable tabs that can each be associated with a target, such as another form or a database report.

When one of the selectable tabs on the navigation control 202 is selected using an appropriate user input device, the target associated with the selected tab is displayed by the database application 108 in the navigation form 200. As will also be described in greater detail below, multiple navigation controls 202 may be added to the same navigation form 200.

According to embodiments, the database client application program 106 provides a design view mode of operation that includes a user interface through which a user of the client computer 102 may define the contents of the navigation form 200 and the targets of the navigation control 202. The database client application program 106 also provides a form view mode of operation that includes a user interface that allows a user of the client computer 102 to interact with the database application 108, including the navigation form 200 and the navigation control 202. Additional details regarding the creation of a navigation form 200 and the navigation control 202 in the design view and the use of the navigation control 202 in the form view will be provided below.

According to other aspects presented herein, the database client application program 106 also provides additional functionality for publishing a navigation form 200, including the navigation control 202, to the server computer 104. In this regard, a user of the client computer 102 may make a request to the database client application program 106 that the navigation form 200 including the navigation control 202 be published to the server computer 104. In response to receiving such a request, the database client application program 106 is configured to communicate with a Web site 114 via the Web server application program 112 to cause the navigation form 200 and the navigation control 202 to be published to the server computer 104. In this regard, the database client application program 106 may generate a data file utilizing the extensible markup language (“XML”) or the extensible application markup language (“XAML”). It should be appreciated that other types of markup languages or data file formats may be utilized to transmit this information to the server computer 104.

By publishing the navigation form 200 and the navigation control 202 to the server computer 104, the navigation form 200 and the navigation control 202 can be made available by the server computer 104 through a Web interface. In particular, the Web site 114 is configured in one embodiment to receive and respond to requests received from a Web browser application program 110 for the navigation form 200 and the navigation control 202. A version of the database client application program 106, referred to herein as the database server application program 116, may be executing on the server computer 104. Through the use of the database server application program 116, the various features of the database application 108, including the navigation form 200 and the navigation control 202, can be made available through the Web site 114.

According to one embodiment presented herein, the Web site 114 comprises the SHAREPOINT collaboration system from MICROSOFT CORPORATION of Redmond, Wash. It should be appreciated, however, that the embodiments presented herein may be utilized with other types of Web sites from other vendors. It should also be appreciated that although a Web browser application program 110 is described herein as being utilized to interact with the Web site 114, including the navigation form 200 and the navigation control 202, any type of program capable of requesting and rendering a Web page may be utilized.

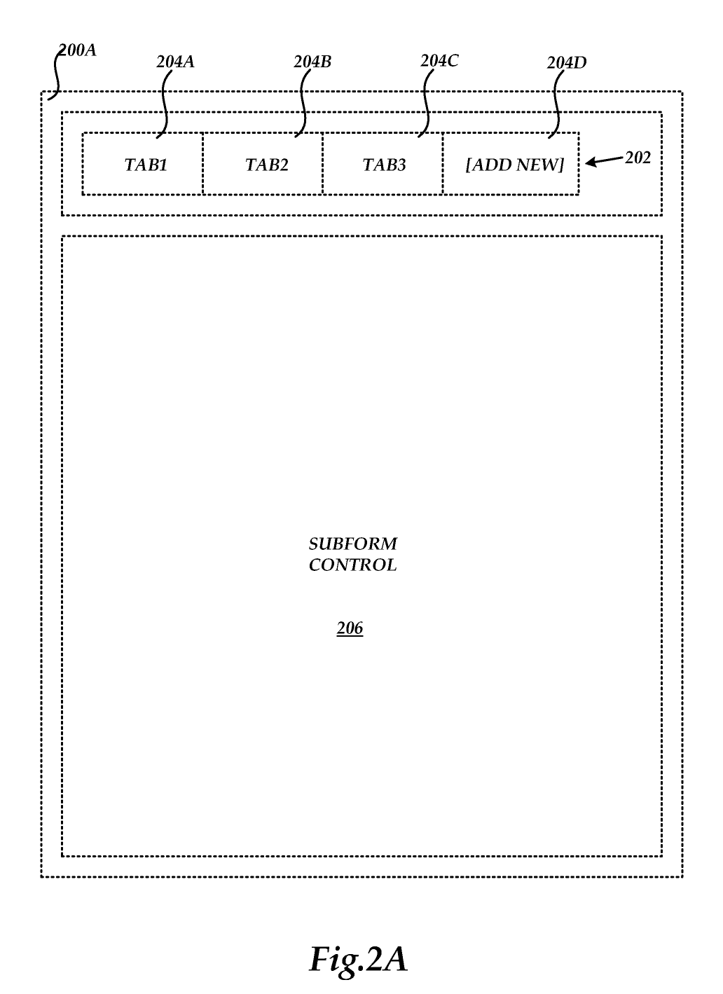

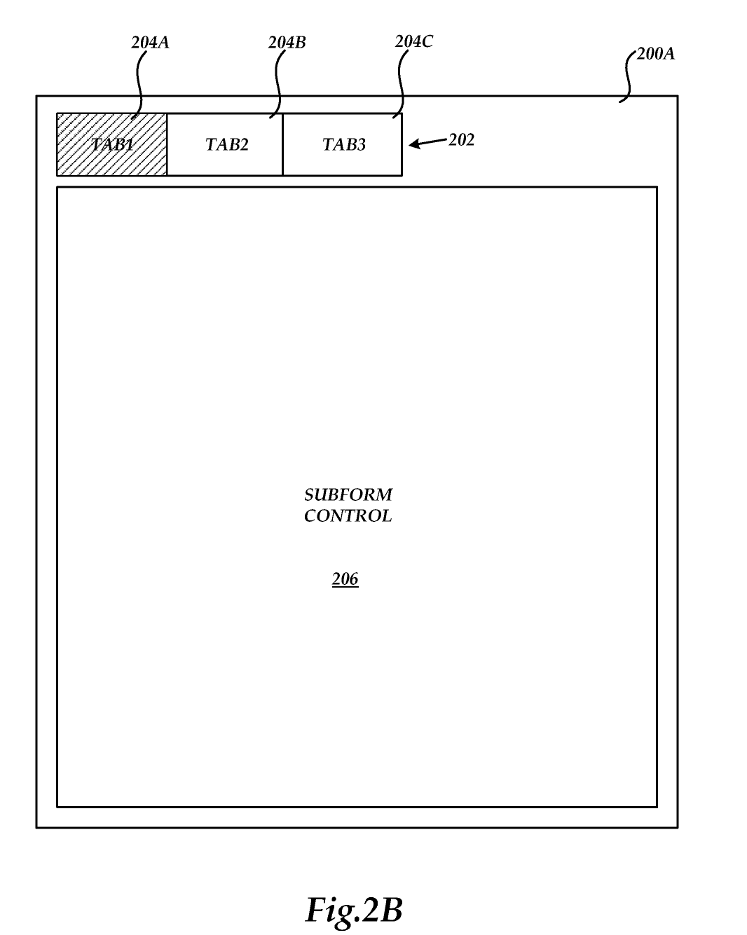

It should be appreciated that the navigation form 200 and the navigation control 202 provided by the client computer 102 appear and operate in a substantially similar manner to the navigation form 200 and the navigation control 202 provided through a Web-based interface by the server computer 104. By allowing a user of the client computer 102 to quickly define the navigation form 200 and the navigation control 202 and to easily publish the form 200 and the control 202 to the server computer 104 for access through a Web-based interface, the embodiments presented herein provide significant benefits over previous solutions for creating a Web-based version of a database application program. Additional details regarding the creation and use of the navigation form 200 and the navigation control 202 provided herein will be described in greater detail below with reference to FIGS. 2A-9.

Referring now to FIG. 2A, additional details will be provided regarding the construction and operation of the navigation form 200 and the navigation control 202 in one embodiment presented herein. In particular, FIG. 2A shows a navigation form 200A in a design view mode of operation provided by the database client application program 106. As discussed above, the user interface provided in the design view allows a user to define the form 200A, including a navigation control 202.

As shown in FIG. 2A, the form 200A includes a navigation control 202 that includes three selectable tabs 204A-204C. As discussed briefly above, each of the tabs 204A-204C may be associated with a target, such as a form or report. When selected in the form view mode of operation provided by the database client application program 106, each of the tabs 204A-204C will cause the target associated therewith to be displayed in the subform control 206. For instance, if the tab 204A is associated with a report and this tab is selected in the form view provided by the database client application program 106, the report associated with the tab 204A will be displayed in the subform control 206.

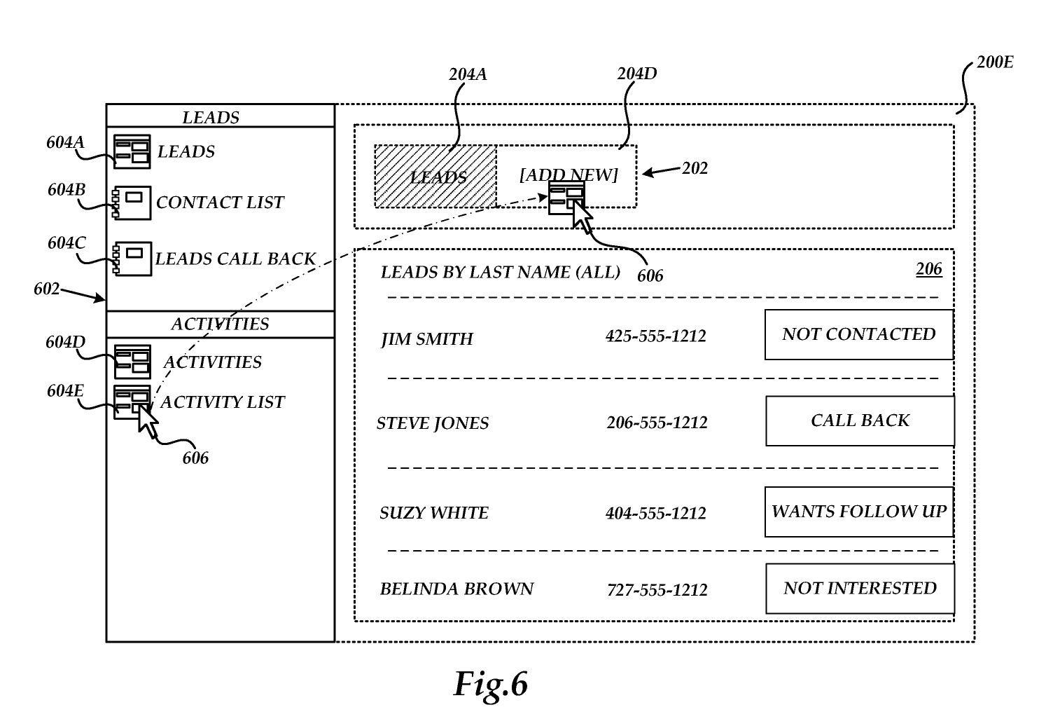

According to embodiments, the database client application program 106 provides functionality for adding a new tab 204 to the navigation control 202. For instance, in one implementation, a tab 204D is reserved for adding a new tab to the navigation control 202. Through the selection of the tab 204D, label text may be defined for the new tab. An appropriate user interface may also be provided for specifying the target of the newly added tab. For instance, a non-modal dialog box may be displayed for specifying the target. Alternatively, and as will be described in greater detail below, a “drag and drop” mechanism may be provided by the database client application program 106 for defining a target. Utilizing this mechanism, a user of the client computer 102 may drag a visual representation of the desired target onto the tab 204D in order to define the target for the new tab in the navigation control 202. Additional details regarding this process will be provided below with reference to FIG. 6.

FIG. 2B illustrates a rendering of the form 200A provided by the database client application program 106 in the form view. In this view, the tab 204D for adding a new tab to the control 202 has been removed. Additionally, the tab that is currently selected within the navigation control 202 has been indicated by setting a display attribute on the selected tab. For instance, in the example shown in FIG. 2B, the tab 204A is the selected tab and is therefore displayed in a manner to distinguish it from the other tabs 204B-204C. Additionally, although not shown in FIG. 2B, the target associated with the tab 204A is displayed in the subform control 206 while in the form view mode provided by the database client application program 106. It should be appreciated that while FIGS. 2A-2B illustrate a form 200A having three tabs 204A-204C, virtually any number of tabs may be utilized. It should be further appreciated that while the tabs illustrated in FIGS. 2A-2B are shown as rectangles, other types of shapes may be defined for the tabs 204A-204C. Alternatively, hyperlinks may be utilized to provide the functionality of the tabs.

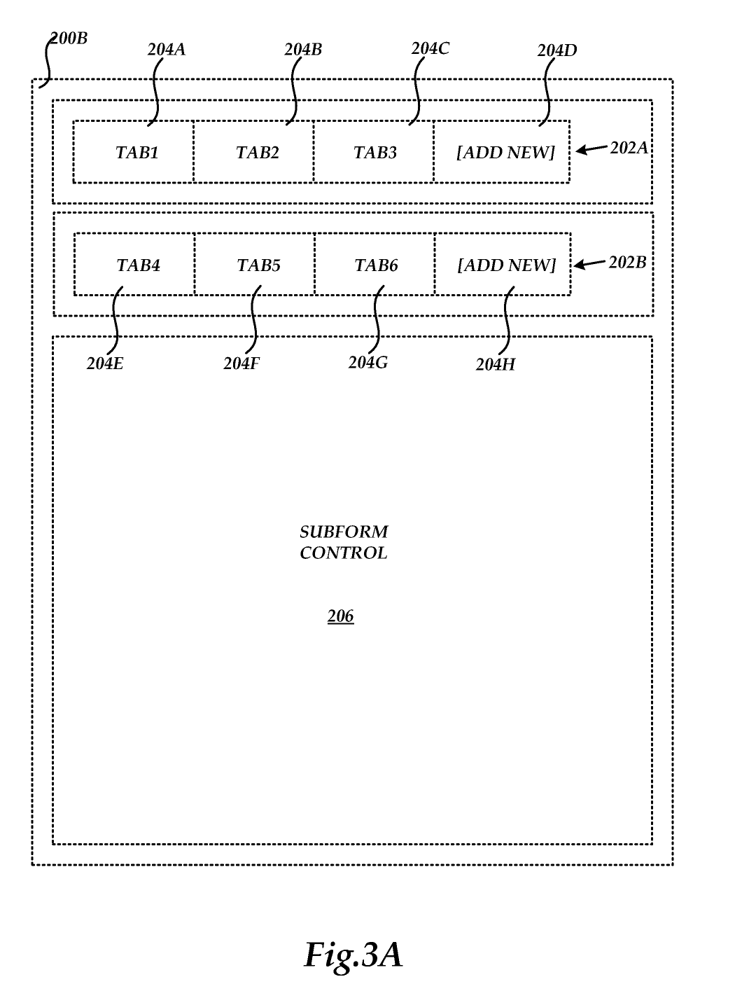

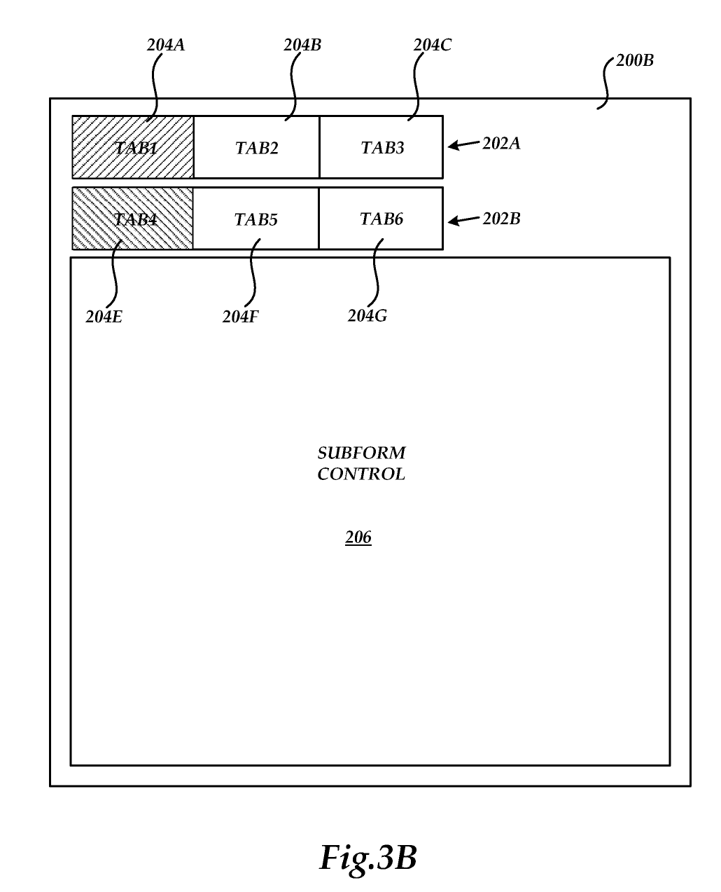

Referring now to FIG. 3A, the creation of a form 200B having two navigation controls 202A-202B contained therein will be described. In particular, FIG. 3A shows a form 200B in the design view mode of operation provided by the database client application program 106. In the form 200B, a user has created a first navigation control 202A that includes the tabs 204A 204C. Additionally, a second navigation control 202B has also been added to the form 200B that includes the tabs 204E-204G. When a form 200B is created in this manner that includes multiple navigation controls 202A-202B, the navigation controls 202A-202B share the same subform control 206. However, the tabs 204E-204G of the navigation control 202B show different content and are associated with different targets depending on the tab 204A-204C that is currently selected in the navigation control 202A. Moreover, one or more of the tabs 204E-204H may or may not be presented depending upon which of the tabs 204A-204D is selected. There may also be additional tabs not shown in FIG. 3A that appear depending upon which of the tabs 204A-204D is selected. In this regard, it should be appreciated that the number of tabs shown in the control 202B can vary depending upon which tab is selected in the control 202A. In the embodiment illustrated in FIG. 3A, the tabs 204E-204G in the control 202B appear in a cell in the layout of the form 200B that is parallel to the tabs 204A-204C in the control 202A. As will be described in greater detail below, other types of layouts may be provided.

In order to set the targets of the tabs 204E-204G, one of the tabs 204A-204C is first selected. Once one of the tabs 204A-204C has been selected, the targets for the tabs 204E-204G can be defined in the manner described above. This process can be repeated until the targets have been set for each combination of the tabs 204A-204C and the tabs 204E-204G.

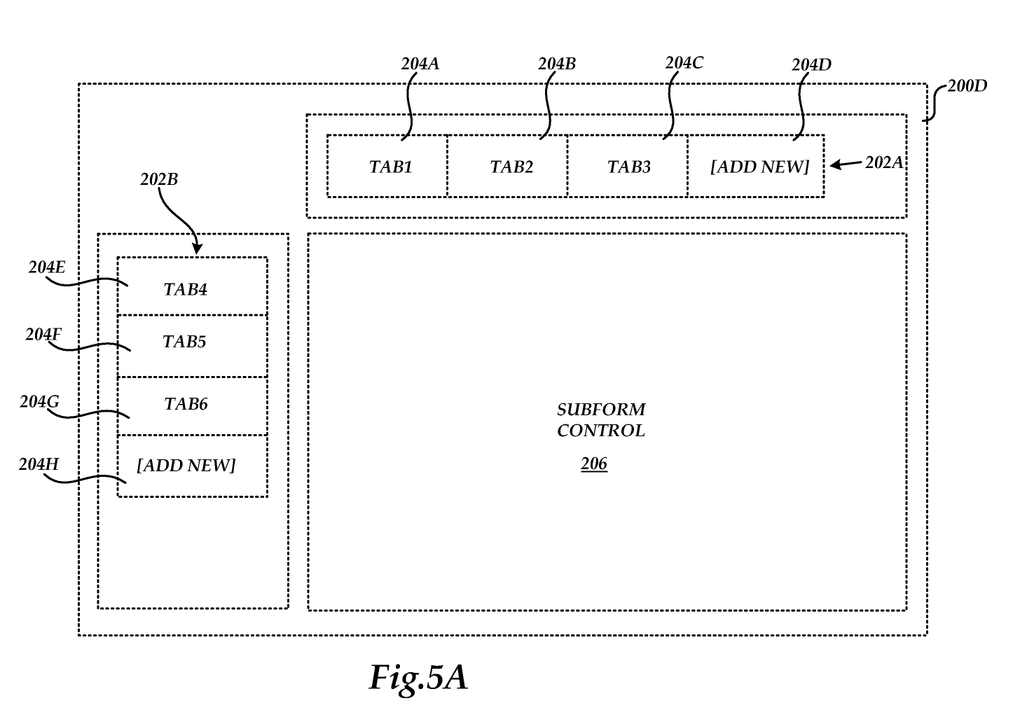

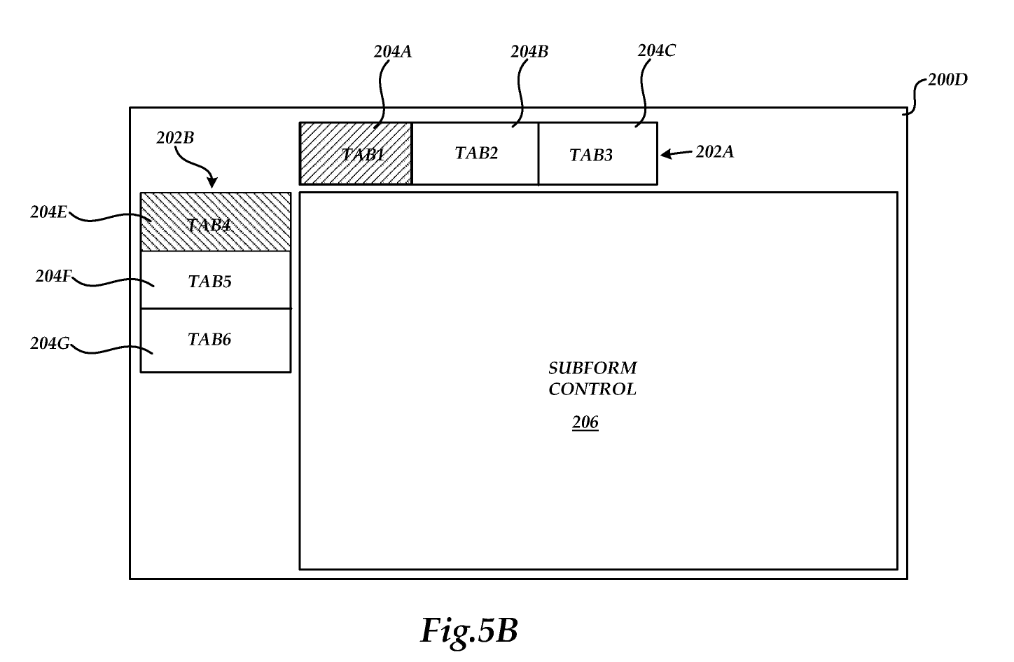

FIG. 3B shows the tab 200B in the form view mode of operation provided by the database client application program 106. As shown in FIG. 3B, the tabs 204D and 204H for adding additional tabs are not displayed in the form 200B in the form view mode of operation. Moreover, as also illustrated in FIG. 3B, the selected tab in the navigation control 202A and the navigation control 202B are visually distinguished from the other tabs. In the example shown in FIG. 3B, the tabs 204A and 204E have been displayed in a manner to visually distinguish them from the tabs 204B-204C and 204F-204G, respectively. In this example, it should be appreciated that the target associated with the tab 204E is displayed in the subform control 206, although not illustrated in this manner. Additional details regarding the use of multiple navigation controls 202 within a single navigation form 200 will be provided below with respect to FIGS. 5A-5B.

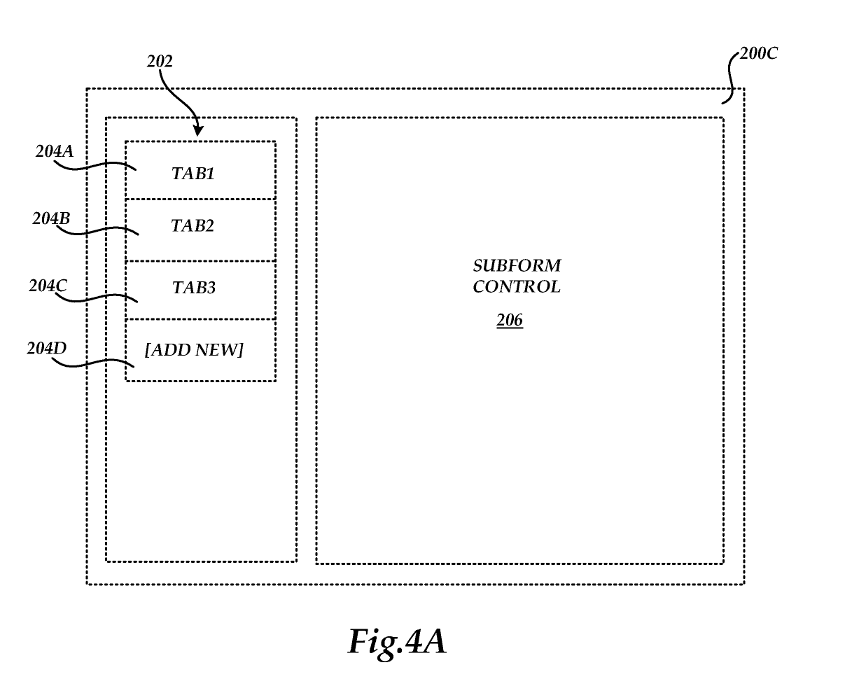

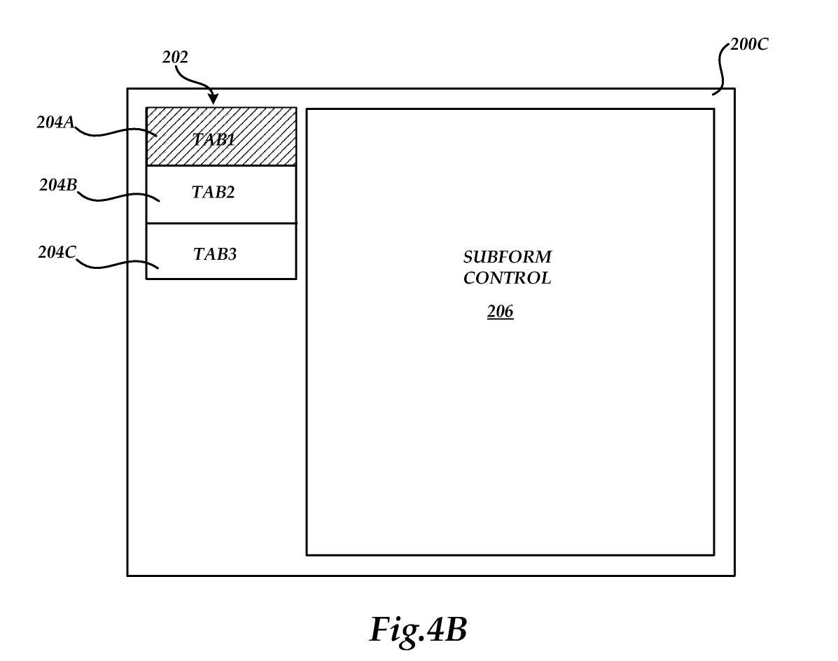

Referring now to FIG. 4A, a navigation form 200C will be described that includes a navigation control 202 that is presented in a vertical orientation. In particular, FIG. 4A shows a navigation form 200C in the design view mode of operation provide by the database client application program 106. The form 200C includes a single navigation control 202. However, the navigation control 202 in the form 200C is presented in a vertical orientation. In this manner, the tabs 204A-204C are presented vertically with the subform control 206 presented to the right thereof. It should be appreciated that the navigation control 202 may also be displayed to the right of the subform control 206. A new tab may be added to the navigation control 202 through the use of the tab 204D in the manner described above. FIG. 4B shows the form 200C in the form view mode of operation provided by the database client application program 106.

FIG. 5A shows a second layout for a navigation form 200D that utilizes multiple navigation controls 202A-202B. In this illustrative embodiment, the navigation control 202A is presented across the top of the navigation form 200D. The navigation control 202B is presented in a vertical orientation at the left side of the subform control 206. Alternatively, the navigation control 202B may be presented to the right of the subform control 206.

As discussed above with reference to FIGS. 3A-3B, the tabs 204A-204C of the navigation control 202A control the content displayed in the tabs 204E-204G and the targets associated therewith. For instance, the tab 204A may be displayed with a first set of targets in the tabs 204E-204G. The tab 204B may be associated with a second set of targets in the tabs 204E-204G. Likewise, the tab 204C may be associated with a third set of targets in the tabs 204E-204G.

Selection of one of the tabs 204A-204C will cause the appropriate set of text labels to be displayed in the tabs 204E-204G. Subsequent selection of one of the tabs 204E-204G will cause the target associated with the selected tab to be displayed in the subform control 206. It should also be appreciated that additional tabs may be added to the controls 202A-202B through the use of the tabs 204D and 204H in the manner described above. Moreover, while two navigation controls 202A-202B have been described herein, the embodiments presented herein may be utilized to cascade virtually any number of navigation controls 202. FIG. 5B shows the navigation form 200D in the form view mode of operation provided by the database client application program 106.

Turning now to FIG. 6, additional details will be provided regarding one process presented herein for adding a new tab 204 to a navigation control 202 and for specifying the target of the newly added tab. In particular, FIG. 6 shows a navigation form 200E in the design view mode of operation provided by the database client application program 106. The form 200E includes a navigation control 202 having a single tab 204A. In this example, the tab 204A has been selected, thereby causing the target of the tab 204A to be displayed in the subform control 206.

In the illustrative example shown in FIG. 6, an object list 602 is also displayed adjacent to the display of the form 200E. The object list 602 includes visual identifiers 604A-604E corresponding to various targets that may be utilized within the form 200E. As discussed above, the targets may include forms or reports. It should be appreciated, however, that the target of a tab 204 may include any type of data view.

In order to add a new tab to the navigation control 202, a user may select one of the visual indicators 604A-604E in the object list using an appropriate user input device. Once one of the visual indicators 604A-604E has been selected, a user may drag the selected visual indicator to the tab 204D. For instance, in the example shown in FIG. 6, a mouse cursor 606 has been placed on the visual indicator 604E, the visual indicator 604E has been selected, and the visual indicator 604E has been dragged to the tab 204D.

Once the visual indicator 604E is released onto the tab 204D, a new tab will be created in the navigation control 202. Moreover, the target of the newly added tab will be set as the form or report to which the visual indicator 604E corresponds. In this manner, a user can add new tabs to a navigation control 202 and define the targets of those tabs in a quick and easy manner. It should be appreciated that any number of new tabs may be added in a similar fashion and that tabs may be added to multiple navigation controls within the same navigation form in a similar way.

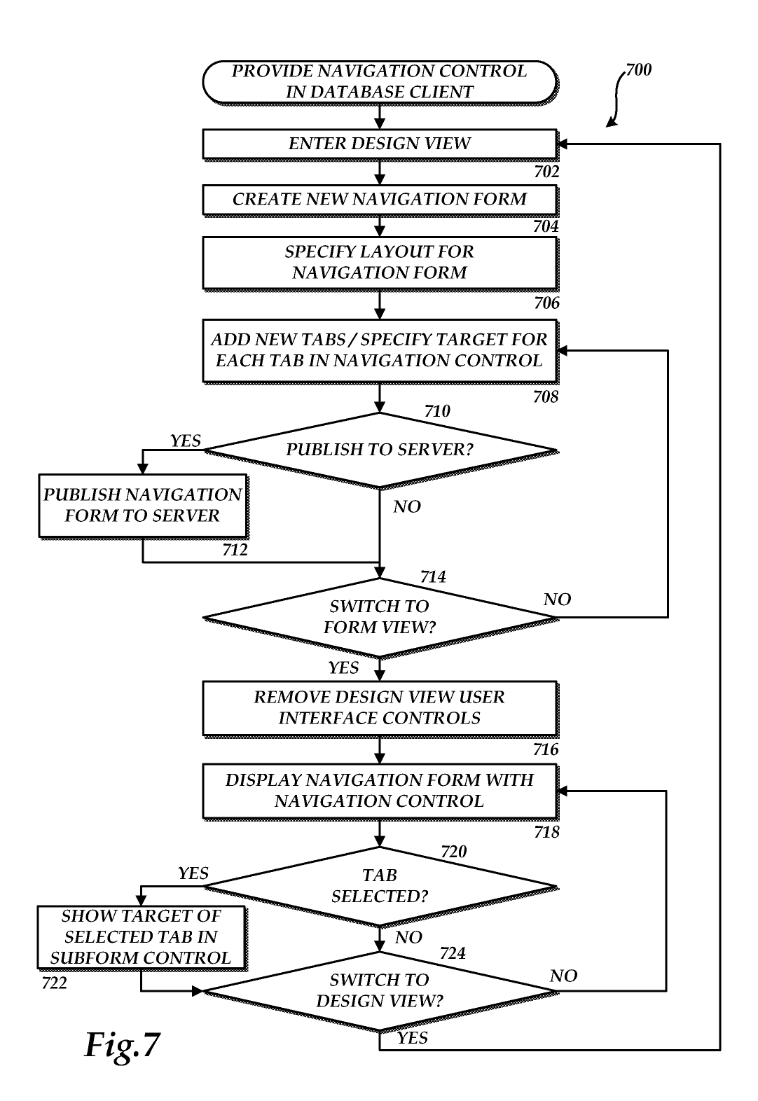

Referring now to FIG. 7, additional details will be provided regarding the embodiments presented herein for providing a common navigation mechanism for client and Web-based applications. In particular, FIG. 7 is a flow diagram showing aspects of one process for providing a navigation control in a client application in one embodiment presented herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 700 begins at operation 702, where the database client application program 106 enters the design view mode of operation. As discussed above, the design view mode of operation provides a user interface for defining a navigation form 200 that includes one or more navigation controls 202.

Once the design view has been entered at operation 702, the routine 700 proceeds to operation 704 where a new navigation form 200 is created. According to embodiments, a navigation form 200 may be provided as a default navigation mechanism for a new database application 108. Alternatively, a user may be required to select a navigation form 200 for use with a new database application 108.

Once a new navigation form has been created at operation 704, a user of the client computer 102 may be requested to specify a layout for the new navigation form 200. In particular, a gallery of possible layouts for a new navigation form 200 may be displayed and the user may be requested to select one of the available layouts. For instance, the navigation gallery may include selectable items corresponding to a navigation form having a horizontal layout such as the form 200A illustrated in FIGS. 2A-2B, a navigation form having multiple navigation controls 202A-202B such as the navigation form 200B illustrated in FIGS. 3A-3B, a form 200C having a navigation control 202 in a vertical orientation, such as the form 200C described above with reference to FIG. 4A-4B, or a navigation form having navigation controls 202A-202B laid out in a hybrid horizontal and vertical orientation such as the form 200D described above with reference to FIGS. 5A-5B. Other possible layouts may also be presented to a user.

In response to receiving the selection of a layout for the new navigation form 200, the new navigation form is created and laid out according to the selected layout at operation 706. Once the new navigation form 200 has been displayed, the routine 700 proceeds to operation 708, where a user is permitted to add new tabs and to specify the target for each tab in the navigation controls within the navigation form 200. New tabs may be added and targets may be specified using the various mechanisms described above.

From operation 708, the routine 700 proceeds to operation 710, where the database client application program 106 determines whether a request has been received from a user of the client computer 102 to publish the navigation form 200, including the navigation control 202, to the server computer 104. In response to such a request, the routine 700 proceeds to operation 712, where the database application 108, including the navigation form 200 and the navigation control 202, are published to the server computer 104 in the manner described above. Once the publication of the database application 108 has been completed, the routine 700 proceeds from operation 712 to operation 714. It should be appreciated that a form need not be in the design mode of operation or even open in order to be published.

At operation 714, the database client application program 106 determines whether a user has requested to enter the form view mode of operation. As described above, the form view mode of operation provides a user interface for interacting with a form 200 to utilize the navigation control 202 to view and interact with the associated targets. If a user has not requested to enter the form view mode of operation, the routine 700 returns to operation 708 described above, where additional tabs may be added to the navigation control 202 and the targets for each of the tabs specified.

If a request has been received to switch to the form view mode of operation provided by the database client application program 106, the routine 700 proceeds to operation 716. At operation 716, user interface controls associated with the design view are removed from the display of the form 200. For instance, the tabs presented in the design view for adding new tabs to a navigation control may be removed. The routine 700 then proceeds to operation 718, where the navigation form 200 is displayed with the navigation control 202. Additionally, the target associated with a default tab may be displayed by the database client application program 106 in the subform control 206 upon entering the form view mode of operation.

From operation 718, the routine 700 proceeds to operation 720, where a determination is made as to whether one of the tabs of the navigation control 202 has been selected using an appropriate user input device. If so, the routine 700 proceeds from operation 720 to operation 722.

At operation 722, the database client application program 106 displays the target associated with the selected tab within the subform control 206. From operation 722, the routine 700 proceeds to operation 724, where the database client application program 106 determines whether a request has been received to return to the design view mode of operation. If not, the routine 700 returns to operation 718 where additional interaction may be performed with respect to the navigation control 202.

If a request is received to reenter the design view mode of operation, the routine 700 returns from operation 724 to operation 702. It should be appreciated that the operations described above may be performed any number of times in order to define the navigation form 200 and the navigation control 202 and to interact with the defined form 200 and control 202. It should also be appreciated that, according to embodiments, the form view mode of operation provided by the database client application program 106 may be provided by a runtime version of the database client application program 106. In this manner, a client computer 102 equipped with a runtime version of the database client application program 106 can provide the functionality described herein for allowing a user to interact with the database application 108 including the navigation form 200 and the navigation control 202. However, a runtime version of the database client application program 106 would not provide functionality for modifying the navigation form 200 or the navigation control 202 or for publishing the form to a server in the manner described above.

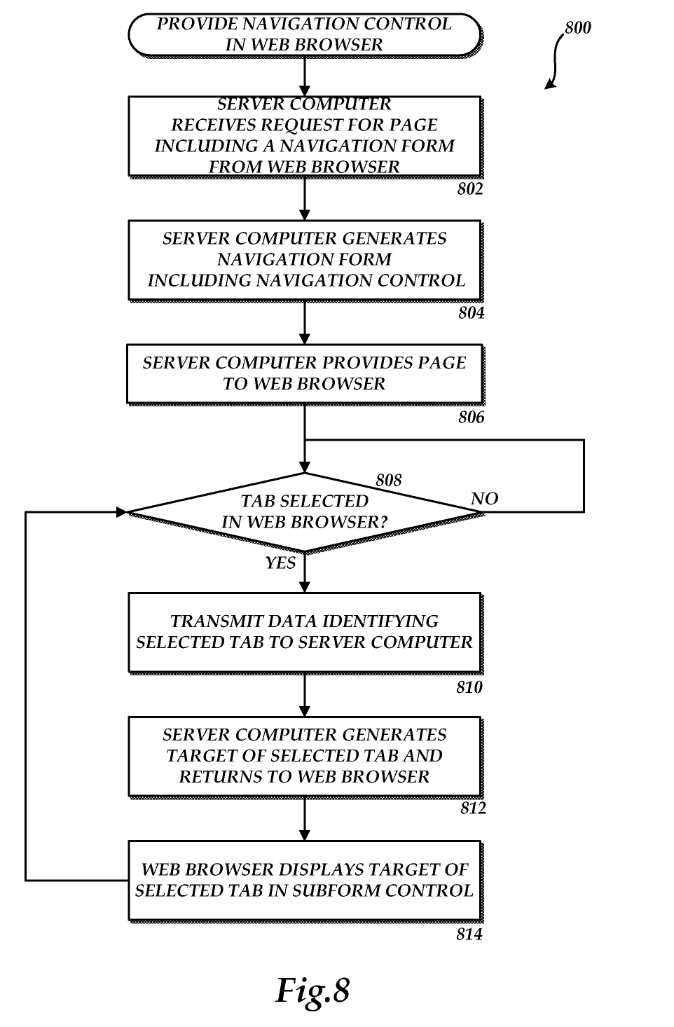

Turning now to FIG. 8, an illustrative routine 800 will be described that illustrates operations performed by the server computer 104 for providing the navigation form 200 and the navigation control 202 through a Web-based interface. The routine 800 begins at operation 802, where the server computer 104 receives a request from the Web browser application program 110 for a page of the Web site 114 that includes a navigation form 200. In response to receiving such a request, the Web site 114 generates the navigation form 200, including the navigation control 202. It should be appreciated that custom controls may be installed at the server computer 104 in order to allow the Web site 114 to generate the navigation form 200 in a manner that is substantially similar to the navigation form 200 provided by the database client application program 106.

Once the navigation form 200 has been generated by the server computer 104, the generated page is provided to the Web browser application program 110 in response to the original request. This occurs at operation 806. Once the navigation form 200 has been provided to the Web browser application program 110, a determination is made at operation 808 as to whether one of the tabs 204 within the navigation control 202 and the navigation form 200 has been selected within the Web browser 110. If a tab has been selected, the routine 800 proceeds from operation 808 to operation 810, where the Web browser application program 110 transmits data to the server computer 104 identifying the selected tab. In response to receiving such data, the server computer 104 generates the target of the selected tab by utilizing services provided by the database server application program 116 and returns the results to the Web browser application 110 for display. This occurs at operation 812.

At operation 814, the Web browser application program 110 displays the target of the selected tab in a subform control within the browser 110. The routine 800 then returns from operation 814 to operation 802, where additional tabs may be selected and displayed in a similar manner. It should be appreciated that various technologies may be utilized at the server computer 104 and the Web browser application program 110 to provide in-place navigation within the navigation form 200. For instance, asynchronous JAVASCRIPT and other technologies known in the art may be utilized. Through the use of these technologies, the navigation form 200 and the navigation control 202 not only appear substantially similar to the navigation form 200 and navigation control 202 provided by the database client application program 106, but they may also provide substantially similar functionality when used in the Web-based interface.

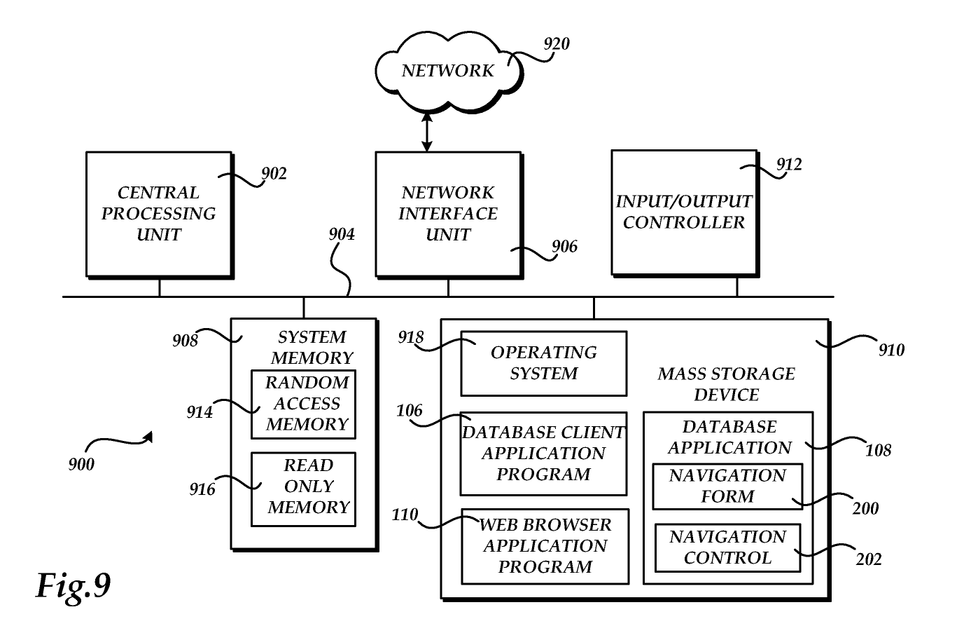

FIG. 9 shows an illustrative computer architecture for a computer 900 capable of executing the software components described herein for providing a common navigation mechanism for client and Web-based applications. The computer architecture shown in FIG. 9 illustrates a conventional desktop, laptop, or server computer and may be utilized to execute any aspects of the software components presented herein described as executing on the client computer 102 or the server computer 104.

The computer architecture shown in FIG. 9 includes a central processing unit 902 (“CPU”), a system memory 908, including a random access memory 914 (“RAM”) and a read-only memory (“ROM”) 916, and a system bus 904 that couples the memory to the CPU 902. A basic input/output system containing the basic routines that help to transfer information between elements within the computer 900, such as during startup, is stored in the ROM 916. The computer 900 further includes a mass storage device 910 for storing an operating system 918, application programs, and other program modules, which are described in greater detail herein.

The mass storage device 910 is connected to the CPU 902 through a mass storage controller (not shown) connected to the bus 904. The mass storage device 910 and its associated computer-readable media provide non-volatile storage for the computer 900. Although the description of computer-readable media contained herein refers to a mass storage device, such as a hard disk or CD-ROM drive, it should be appreciated by those skilled in the art that computer-readable media can be any available computer storage media that can be accessed by the computer 900.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 900.

According to various embodiments, the computer 900 may operate in a networked environment using logical connections to remote computers through a network such as the network 920. The computer 900 may connect to the network 920 through a network interface unit 906 connected to the bus 904. It should be appreciated that the network interface unit 906 may also be utilized to connect to other types of networks and remote computer systems. The computer 900 may also include an input/output controller 912 for receiving and processing input from a number of other devices, including a keyboard, mouse, or electronic stylus (not shown in FIG. 9). Similarly, an input/output controller may provide output to a display screen, a printer, or other type of output device (also not shown in FIG. 9).

As mentioned briefly above, a number of program modules and data files may be stored in the mass storage device 910 and RAM 914 of the computer 900, including an operating system 918 suitable for controlling the operation of a networked desktop, laptop, or server computer. The mass storage device 910 and RAM 914 may also store one or more program modules. In particular, the mass storage device 910 and the RAM 914 may store the database client application program 106, the Web browser application program 110, and the database application 108, including the navigation form 200 and the navigation control 202, each of which was described in detail above with respect to FIGS. 1-8. The mass storage device 910 and the RAM 914 may also store other types of program modules and data.

It should be appreciated that, according to other embodiments, security-based filtering of the tabs of a navigation control may also be performed. According to this aspect, properties may be specified on each tab that identifies the user or users who have permission to use that tab. When these users are using the database on a client or on the server, the tab is displayed and enabled for use. For other users that do not have permission, the tab is hidden or otherwise disabled.

It should also be appreciated that, in another embodiment, tabs may be provided on a navigation control that use a “Where condition” to filter the data in a target form. Through the utilization of this aspect, it is possible to create multiple tabs that all target the same form but that show different results. For example, a customer list form may be dragged and dropped into a navigation control. A Where condition may then be set on the navigation tab (e.g. “[State]=‘WA’”). The tab has now become a “Customer in Washington State” tab and will only display records that satisfy the Where condition statement. This process can be repeated for other tabs in order to reuse the form but to cause a different set of data to be displayed when the other tabs are selected.

Based on the foregoing, it should also be appreciated that technologies for providing a common navigation mechanism for client and Web-based applications have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing a common navigation control for use in a client application and in a server application, the method comprising performing computer-implemented operations for:
providing in the client application a user interface for defining a form including the navigation control;
providing in the client application a user interface for interacting with the form to utilize the navigation control to view a plurality of targets;
receiving a request at the client application to publish the form including the navigation control to a server computer executing the server application; and
in response to receiving the request, publishing the form including the navigation control to the server computer, whereby the server application is configured to provide the form and the navigation control via a Web interface.

2. The method of claim 1, wherein the navigation control comprises a plurality of selectable tabs, each of the selectable tabs associated with a target and which, when selected, will cause the target associated with the selected tab to be displayed in the form.

3. The method of claim 2, wherein the client application program is further configured to permit a second navigation control to be added to the form, the second navigation control comprising a second plurality of selectable tabs, each of the second plurality of tabs associated with a target and which, when selected, will cause the target associated with the selected tab to be displayed in the subform control, and wherein the tabs of the first navigation control define the targets of the plurality of second selectable tabs.

4. The method of claim 3, wherein the server application is further configured to make the form including the second navigation control available via the Web interface.

5. The method of claim 4, wherein the form further comprises a subform control and wherein the target is displayed in the subform control.

6. The method of claim 5, wherein each target comprises one of a form or a report.

7. The method of claim 6, wherein the client application program comprises a database application program.

8. A system for providing a common navigation control for use in a client application and in a server application, the system comprising:
a client application program configured to provide a user interface for creating a form comprising a first navigation control having a plurality of selectable tabs, each of the tabs associated with a target and which, when selected, will cause the target associated with the selected tab to be displayed in the form, the client application program further configured to publish the form and the first navigation control to a server application; and
a server application configured to receive a request from the client application program to publish the form and, in response thereto, to make the form and the navigation control available by way of a Web interface.

9. The system of claim 8, wherein the client application program is further configured to permit a second navigation control to be added to the form, the second navigation control comprising a second plurality of selectable tabs, each of the second plurality of tabs associated with a target and which, when selected, will cause the target associated with the selected tab to be displayed in the subform control, and wherein the tabs of the first navigation control define the targets of the plurality of second selectable tabs.

10. The system of claim 9, wherein the server application is further configured to make the form including the second navigation control available via the Web interface.

11. The system of claim 10, wherein the form further comprises a subform control and wherein a target is displayed by the subform control in response to receiving a selection of a tab.

12. The system of claim 11, wherein the client application program comprises a database application program.

13. The system of claim 12, wherein each target comprises one of a form or a report.

14. The system of claim 13, wherein the tabs of the first navigation control are oriented horizontally or vertically on the form.

15. A computer storage medium having computer executable instructions stored thereon which, when executed by a computer, cause the computer to:
provide a user interface in a database application program for creating a form comprising a first navigation control and a subform control, the first navigation control comprising a plurality of selectable tabs, each of the tabs associated with a target and which, when selected, will cause the target associated with the selected tab to be displayed in the subform control;
receive a request at the database application program to publish the form to a server computer; and
in response to receiving the request to publish the form to the server computer, to publish the form and the first navigation control to the server computer, whereby the server computer is configured to provide the form and the first navigation control through a Web interface.

16. The computer storage medium of claim 15, wherein the form further comprises a second navigation control comprising a second plurality of selectable tabs, each of the second plurality of tabs associated with a target and which, when selected, will cause the target associated with the selected tab to be displayed in the subform control, and wherein the tabs of the first navigation control define the targets of the plurality of second selectable tabs.

17. The computer storage medium of claim 16, wherein the target comprises a form.

18. The computer storage medium of claim 17, wherein the target comprises a report.

19. The computer storage medium of claim 18, wherein the tabs of the first navigation control are oriented horizontally on the form.

20. The computer storage medium of claim 19, wherein the tabs of the first navigation control are oriented vertically on the form.
